(19) United States
(12) Patent Application Publication
(10) Pub. No.: US 2021/0061285 A1
(43) Pub. Date: Mar. 4, 2021

(54) METHOD FOR GENERATING A REFERENCE REPRESENTATION

(71) Applicant: Robert Bosch GmbH, Stuttgart (DE)

(72) Inventors: Achim Feyerabend, Heilbronn (DE); Heinz Hertlein, Erlenbach (DE); Oliver Pink, Ditzingen (DE); Thomas Goeppel, Obersulm-Affaltrach (DE)

(21) Appl. No.: 16/992,554

(22) Filed: Aug. 13, 2020

(30) Foreign Application Priority Data
Sep. 3, 2019 (DE) 102019213316.9

(51) Int. Cl. B60W 40/02; B60W 50/14; G06K 9/00; H04W 4/46

(52) U.S. Cl. CPC B60W 40/02; B60W 50/14; B60W 2554/40; H04W 4/46; B60W 2556/65; G06K 9/00791

(57) ABSTRACT

A method for generating a reference representation of the surroundings of an at least semi-automated mobile platform is provided. The method includes ascertaining at least one third-party platform for receiving reference data for the reference representation of the surroundings of the mobile platform; establishing a communication channel of the mobile platform to the at least one third-party platform; receiving the reference data of the at least one third-party platform for the reference representation of the surroundings; ascertaining the received reference data that are relevant to the generation of the reference representation; storing the relevant reference data of the at least one third-party platform for the generation of the reference representation of the surroundings.

### CROSS REFERENCE

The present application claims the benefit under 35 U.S.C. § 119 of German Patent Application No. DE 102019213316.9 filed on Sep. 3, 2019, which is expressly incorporated herein by reference in its entirety.

### FIELD

The present invention relates to a method for generating a reference representation of the surroundings of at least one semi-automated mobile platform.

### BACKGROUND INFORMATION

The implementation of the perception or representation of the surroundings is highly important for implementing an at least semi-automated driving operation having an at least semi-automated mobile platform, but also increasingly for driver assistance systems. Here, the surroundings are detected with the aid of sensors and determined with the aid of methods for pattern recognition, for example. The data of the sensors are thus transferred to a symbolic and semantic description of the relevant aspects of the surroundings. This symbolic and semantic description of the surroundings then forms a basis for carrying out actions in the thus described surroundings or for an application or an intended purpose using an at least semi-automated mobile platform, for example. One typical example of a symbolic description of the surroundings is to describe static and/or dynamic objects with the aid of attributes that characterize the position, shape, size, speed, etc. of the particular object, for example, and to assign an ethical, a legal or a similar meaning to these objects, for example. The objects may include obstacles, for example, with which a collision must be avoided.

For the development, safeguarding, evaluation, validation of algorithms of different systems for an at least semi-automated driving operation and for training machine learning methods for the use in at least semi-automated driving operations, such as for deep learning for example, different types of reference data are needed to describe the surroundings. These are, among other things, labeled samples of sensor data that are measured with the aid of an at least semi-automated mobile platform as well as recordings including ground truth data that represent a preferably accurate description of the surroundings of the mobile platform.

### SUMMARY

Ground truth data are generally generated with the aid of special mobile platforms that are equipped with a higher-quality and a more accurate sensor system than the system to be tested. For example, a combination of LIDAR, radar, and video might be used as a reference for the development of a video-only AEB function (autonomous emergency braking (system)). The disadvantage of this method is that only a small test fleet may be generally equipped with this sensor system, in particular due to financial considerations.

Furthermore, dedicated “hare vehicles” are used that are equipped with a communication device and accurate measuring devices, which transmit these data via a fixed communication channel to the test vehicle, for example.

The present invention provides an example method for generating a reference representation of the surroundings, a device, a computer program as well as a machine-readable memory medium that achieve the above-stated objects at least partially. Advantageous embodiments of the present invention are described herein.

According to one aspect of the present invention, a method is provided for generating a reference representation of the surroundings of an at least semi-automated mobile platform. In accordance with an example embodiment of the present invention, in one step of the method, at least one third-party platform is ascertained for receiving reference data for the reference representation of the surroundings of the mobile platform. In a further step, a communication channel of the mobile platform is established to the at least one third-party platform. In a further step, the reference data of the at least one third-party platform are received for the reference representation of the surroundings. In a further step, the received reference data that are relevant to the generation of the reference representation are ascertained. In a further step, the relevant reference data of the at least one third-party platform are stored for generating the reference representation of the surroundings.

In this entire description of the present invention, the sequence of the method steps is illustrated in such a way that the method is easily comprehensible. Those skilled in the art will recognize, however, that many method steps may also run in a different sequence and lead to the same result. In this sense, the sequence of the method steps may be correspondingly changed and is thus also provided.

This method may be used to ascertain new and interesting scenarios in the field trial and evaluate same with the aid of the reference representation by generating the reference representation with the aid of a third-party platform, which exists in the surroundings of the mobile platform randomly or in a planned manner, for example, and its sensor system or its representation of the surroundings. In this case, a reference representation of the mobile platform may also be generated with the aid of the particular reference data of a plurality of third-party platforms.

This thus gives rise to the possibility of testing or validating or verifying scenarios that go beyond what would have been established in the previously defined scenarios, for example when using a “hare vehicle.”

The method may thus be used, for example, to employ a vehicle, i.e., a third-party platform, having a good-quality sensor configuration and, for example, having an automated driving function, as the “reference sensor system” for generating the reference representation of a vehicle, i.e., the mobile platform, which is proximately located and has a simpler sensor system. Likewise, a vehicle or a third-party platform or an infrastructure system including sensors that are not present in the ego vehicle, i.e., the mobile platform, may complement the data of the ego vehicle in such a way that it makes it possible to generate a reference representation of the surroundings of the mobile platform.

The advantage of this method becomes particularly important in the case of the “open world” problem of a validation or an “open context” interaction of HAD (highly automated driving) operations or service robotics and the complexity connected thereto, since a validation of such an HAD system requires an extreme amount of effort and is thus cost-intensive.

When applying this example method, the mobile platform, in the form of a test vehicle, does not necessarily require a reference sensor system and the third-party platform may be mobile or stationary. In this case, the reference data may be data of a third-party platform that relate to the third-party platform itself, such as for example a position of the mobile third-party platform or a state, such as for example the state of a light signal system and/or the position and/or the meaning of a traffic sign, etc. The reference data may also have object attributes that were determined by the third-party platform, for example with the aid of the sensor system of the third-party platform, in the representation of the surroundings of the third-party platform. Moreover, the reference data may also include direct sensor data of the third-party platform or relate to partial information of the representation of the surroundings of the third-party platform or also relate to the results of the analyses ascertained by the third-party platform as a result of its representation of its surroundings.

According to one aspect, it is provided that to generate a reference representation of the surroundings of an at least semi-automated mobile platform, the received reference data of at least one or a plurality of mobile third-party platforms are chronologically synchronized among each other and/or with at least one infrastructure system and/or with the mobile platform.

According to one aspect, it is provided that this chronological synchronization of the particular internal timers of the mobile platform and/or of the at least one mobile third-party platform and/or of the at least one infrastructure system is/are synchronized with a central time normal in each case. A GPS (global positioning system) may also be named as an example of such a time normal.

According to a further aspect of the preset invention, it is provided that this chronological synchronization of the particular internal timers of the mobile platform and/or of the at least one mobile third-party platform and/or of the at least one infrastructure system take/takes place with the aid of a wireless information network. One example of such a wireless information network is a point-to-point (PTP) network. With the aid of such a synchronization, data or reference data of different data generating systems of the mobile platform or of the mobile third-party platform or of the infrastructure system may be assigned and/or compared to one another, for example.

In this case, the reference representation may have different formats and different contents than the representation that was determined by the mobile platform. The reference representation may be suitable to check one or multiple object attributes or features of the representation of the surroundings of the mobile platform for its/their quality or accuracy. An instantaneous reference representation of the surroundings may thus be improved by the received reference data, in particular with reference to a partial functionality of the mobile platform to be tested.

With the aid of the reference representation of the surroundings of the mobile platform, a system or a partial function of the mobile platform, whose hardware components are connected to the mobile platform, may be tested, verified or validated on the mobile platform itself as well as offline.

To establish the communication channel of the mobile platform, the platform may wirelessly transmit signals that may be picked up and responded to by a third-party platform, if the third-party platform is configured to emit reference data to the mobile platform.

In this case, the relevant reference data are such data that are suitable to check one or multiple features of the representation of the surroundings of the mobile platform for its/their quality or accuracy.

It may be furthermore ascertained, whether the received reference data of the third-party platform are relevant to the representation of the surroundings of the mobile platform, i.e., whether the surroundings of the mobile platform and the surroundings of the third-party platform overlap.

The reference data of the particular third-party platforms may also be of lower quality than the data that were generated with the aid of the sensors of the mobile platform, since an overall quality of the reference representation may also be improved by appropriately fusing a plurality of reference data of multiple third-party platforms, for example.

Such a reference representation may be provided to test or verify or validate at least one partial functionality of the mobile platform. The reference data that are relevant to the generation of the reference representation depend on which reference representation for at least one partial function or partial functionality of the mobile platform to be tested is necessary and which data are available for the mobile platform as a result of the sensors present on the mobile platform, for example.

Five different scenarios for a use of the described example method for generating a reference representation are provided in the following by way of example:

a. The at least one third-party platform transmits its own position, speed, dimensions, etc., as a reference. In this way, this method may be used to carry out test driving operations similar to the test driving operations using a specially equipped “hare vehicle.”

b. An infrastructure system, such as a traffic light for example, transmits its position, signal state, etc., as the reference data to the mobile platform.

c. The at least one third-party platform, such as a third-party vehicle for example, transmits sensor data representing the surroundings and/or the representation of the surroundings or parts of the representation of the surroundings generated by the third-party platform, to generate a reference representation of the surroundings of the mobile platform.

d. Moreover, infrastructure cameras may transmit data from systems of toll bridges and further reference data of their surroundings and/or their representation of their surroundings or parts thereof to generate a reference representation of the surroundings of the mobile platform.

e. The mobile platform transmits specific requests with regard to reference data to a third-party platform and/or an infrastructure system that are necessary to generate a reference representation of the surroundings of the mobile platform. For example, a check request as to whether a specific object of the surroundings was also identified by the corresponding infrastructure or third-party platform. Or check information with reference to a speed of a certain dynamic object at a certain position of the surroundings.

f. Moreover, a third-party platform may provide and transmit information about the environmental conditions of its surroundings, such as the friction coefficients of the road, weather, lighting and visibility conditions, for example.

It is advantageous in this method that credibility issues with regard to the use of data transmitted from vehicle to infrastructure or from vehicle to vehicle, such as those which may occur in the case of attacks from the outside or in the case of errors in the algorithms of the other vehicle or third-party platform or infrastructure component, are irrelevant.

The use of these data for verification or validation is not safety-relevant insofar as a reading-in, i.e., receiving and storing, of erroneous data merely results in the data failing to be verified or validated. It must merely be examined after the event, whether the failure is attributable to the component to be actually checked, to the communication channel or to the third-party system. In any case, however, an actual deficiency of one of the involved systems was discovered.

According to one aspect of the present invention, it is provided that signals are transmitted via the established communication channel in both directions between the mobile platform and the third-party platform.

In this way, the mobile platform may raise targeted information requests with the third-party platform, such as for example to carry out an alignment with regard to the presence of an object detected insecurely, in particular, in the surroundings of the mobile platform or to carry out an alignment abort an estimation with regard to a scenario in the overlapping area of the surroundings of the mobile platform and the third-party platform.

According to one aspect of the present invention, it is provided that the at least one third-party platform is designed as an infrastructure system and/or a mobile platform.

According to one aspect of the present invention, it is provided that the received reference data include sensor data having information for the representation of the surroundings of the mobile platform.

The mobile platform may use these sensor data to complement the sensor data available to the mobile platform and, if necessary, to evaluate them itself or to transmit them for a central evaluation to a central evaluation system for the purpose of generating a reference representation of the surroundings of the mobile platform.

According to one aspect of the present invention, it is provided that the received reference data include object attributes, of the representation of the surroundings of the third-party platform, of the objects of the surroundings of the mobile platform.

In this case, the object attributes include such attributes that also relate to the object third-party platform itself. This means that the third-party platform may for example also transmit its own position to the mobile platform, making it possible for the mobile platform to generate a reference representation of the surroundings of the mobile platform.

The transmission of object attributes of the objects of the surroundings by the third-party platform to the mobile platform has the advantage that the object attributes that were ascertained by the mobile platform itself may thus be either complemented or checked.

According to a further aspect of the present invention, it is provided that the received reference data include information with regard to the environmental conditions of the surroundings of the mobile platform.

The mobile platform may use this information to also take into consideration the information about the environmental conditions, for example, to which it did not have access due to its own design, for the purpose of generating a reference representation.

According to a further aspect of the present invention, it is provided that the received reference data include information, requested by the mobile platform, with regard to the representation of the surroundings of the mobile platform.

As already explained above, this also allows access to the analysis results of the third-party platform or to a selected portion of reference data. In a specific scenario, a mobile third-party platform might be queried, for example, whether it also would have triggered an emergency braking function in this scenario.

According to a further aspect of the present invention, it is provided that the received reference data include information, requested by the mobile platform, with regard to an action of the mobile platform as a result of the representation of the surroundings of the mobile platform.

Such an action of the mobile platform, which is based on an interpretation by the mobile platform with reference to the representation of the surroundings of the mobile platform and was determined, for example, with the aid of an evaluation unit of the mobile platform, may relate to a positive or negative acceleration and/or a change in direction, for example, which is/are used by the mobile platform to respond to its surroundings based on its interpretation of its surroundings.

According to one aspect of the present invention, it is provided that at least some of the received reference data have a quality degree of the reference data.

With the aid of this quality degree of the reference data, the mobile platform or a central evaluation unit may take into consideration, for the generation of a reference representation, what data have a higher quality for the generation of the reference representation and correspondingly take this into consideration for the generation.

One example of such a quality degree may be an error interval with reference to a local localization or a monitoring period.

According to one aspect of the present invention, it is provided that the received reference data are relevant to the generation of the reference representations of the surroundings of the mobile platform, insofar as either a new reference representation of the surroundings may be generated with the aid of the received reference data or an instantaneous reference representation of the surroundings is improved with the aid of the received data. The reference representation in particular does not necessarily have to have the same format and the same content as the representation that is actively used by the at least semi-automated mobile platform. The reference representation should be suitable to check one or multiple object attributes or features of the representation of the mobile platform for its/their quality or accuracy, for example with regard to a partial functionality of the mobile platform to be checked.

According to one aspect of the present invention, it is provided that the received reference data improve the generation of the instantaneous reference representation of the surroundings, insofar as the quality degree of the received reference data of the third-party platform surpasses the quality degree of equivalent data of the mobile platform.

It is to be taken into consideration in this case that an improvement of the reference representation may also be achieved by appropriately fusing the reference data of a plurality of third-party platforms, if the individual reference data of the plurality of third-party platforms have the same quality or even a lower quality than the data made available by the mobile platform itself.

According to a further aspect of the present invention, it is provided that the received reference data improve the generation of the instantaneous reference representations of the surroundings, insofar as that they make it possible to add further object attributes of objects for the instantaneous reference representation of the surroundings or check present object attributes or improve the quality of present object attributes.

According to a further aspect of the present invention, it is provided that the received reference data are only stored as a reference representation of the surroundings, if a minimum of information about the surroundings is present for the mobile platform together with the received reference data.

Such a minimum may be achieved, if at least one property or object attribute of the representation of the surroundings of the mobile platform may be checked with the reference representation of the surroundings of the mobile platform that is relevant with reference to the partial functionality of the mobile platform to be checked. This may involve the distance from a preceding vehicle, for example. This means that the minimum of information about the surroundings of the mobile platform is a function of the test or the verification or the validation that is/are to be potentially carried out in a later step on this reference representation of the surroundings of the mobile platform.

According to a further aspect of the present invention, it is provided that the received reference data are stored with the aid of a memory of the mobile platform and transmitted to an external central processing unit after the driving operation or the received reference data are transmitted to an external central server during the driving operation.

The central processing unit is configured to generate a reference representation of the surroundings.

Since an evaluation capacity of the mobile platform is limited with regard to a representation of the surroundings, for example, the possibility of being able to access a larger processing capacity for determining a reference representation results due to the transmission to a central processing unit, for example.

According to one aspect of the present invention, it is provided that the received reference data are stored with the aid of a memory of the mobile platform. In this case, the mobile platform may be configured to generate a reference representation of the surroundings for at least some of the received data.

According to one aspect of the present invention, it is provided that the mobile platform is configured to generate reference representations of the surroundings for at least some of the received reference data and to store the reference representations with the aid of a memory of the mobile platform.

According to one aspect of the present invention, it is provided that the mobile platform is configured to generate reference representations of the surroundings for at least some of the received reference data, to compare the reference representations to at least a part of the representation of the surroundings of the mobile platform, and to store the result of the comparison with the aid of a memory of the mobile platform. Memory space of the mobile platform may thus be advantageously saved.

This aspect of the method makes it possible moreover to carry out a verification or validation of systems, at least partially, directly in the vehicle and without a server infrastructure, for example. A comparison of the reference representation to the system to be tested takes place directly in the vehicle, after the generation of the reference representation of the surroundings of the mobile platform. It is thus achieved that merely the result of such a comparison is available immediately and in the case of a falsification, further information about the scenario may be transmitted via the diagnosis, if necessary, either immediately or during the next repair shop visit to an, in particular central, server, for example.

According to one aspect of the present invention, it is provided that based on the received reference data, a control signal for activating an at least semi-automated vehicle is made available; and/or based on the received reference data, a warning signal for warning a vehicle occupant is made available.

In this case, the phrase “based on” with regard to the feature is understood to mean that a control signal is made available based on the received reference data. It is to be understood to mean that the received reference data are used for any determination or computation of a control signal, not excluding the additional use of other input variables for this determination of the control signal. The same applies correspondingly to making the warning signal available.

In accordance with an example embodiment of the present invention, a device is provided that is configured to carry out the method as described above. The method may be easily integrated into different systems with the aid of such a device.

In accordance with an example embodiment of the present invention, a computer program is provided that includes commands that prompt the computer to carry out one of the above-described methods when the computer program is carried out by a computer. Such a computer program allows for the use of the described method in different systems.

In accordance with an example embodiment of the present invention, a machine-readable memory medium is provided, on which the above-described computer program is stored.

A mobile platform may be understood to mean an at least semi-automated system that is mobile and/or a driver assistance system of a vehicle. One example may be an at least semi-automated vehicle or a vehicle having a driver assistance system. This means that in this context, an at least semi-automated system includes a mobile platform with regard to an at least semi-automated functionality, but a mobile platform also includes vehicles and other mobile machines, including driver assistance systems. Further examples of mobile platforms may be driver assistance systems including multiple sensors, mobile multi-sensor robots, such as for example robot vacuum cleaners or lawn mowers, a multi-sensor monitoring system, a plane, a ship, a production machine, a personal assistant, or an access control system. Each of these systems may be a fully or semi-automated system.

### DETAILED DESCRIPTION OF EXAMPLE EMBODIMENTS

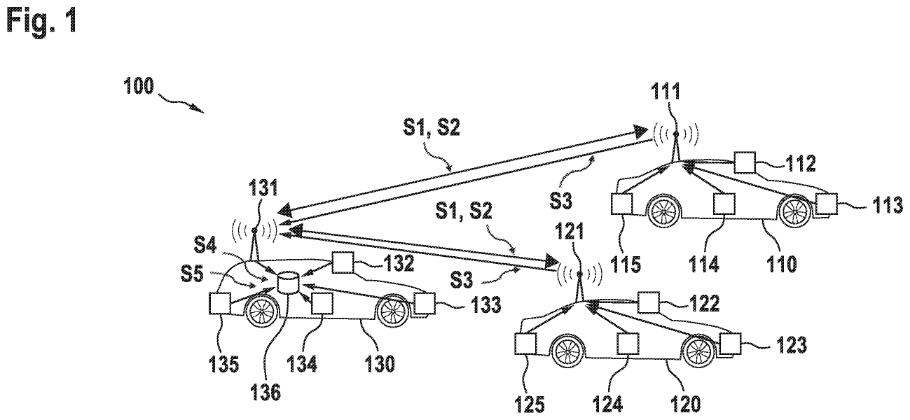

The exemplary embodiments of the present invention are illustrated with reference to FIGS. 1 through 4 and explained in greater detail below.

FIG. 1 shows a drawing of the signal flows for the generation of a reference representation.

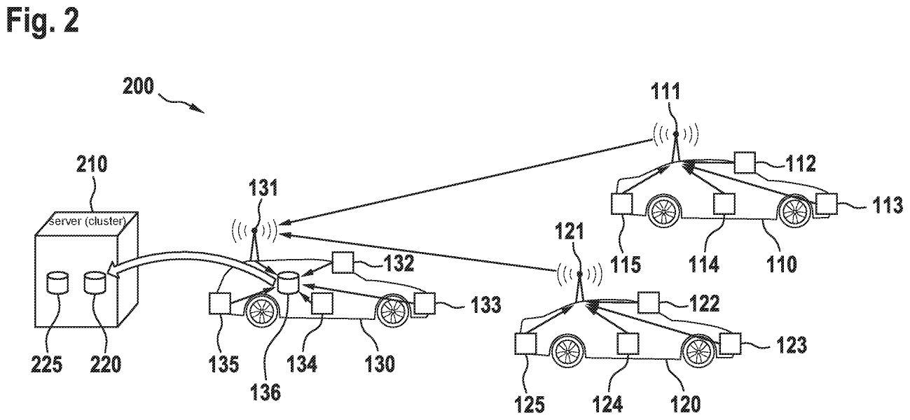

FIG. 2 shows a further drawing of the signal flows for the generation of a reference representation with a central processing system.

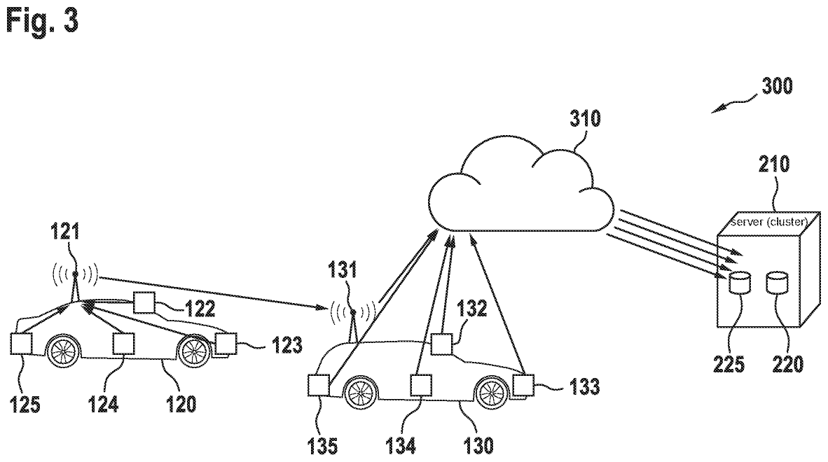

FIG. 3 shows a further drawing of the signal flows for the generation of a reference representation with central storage.

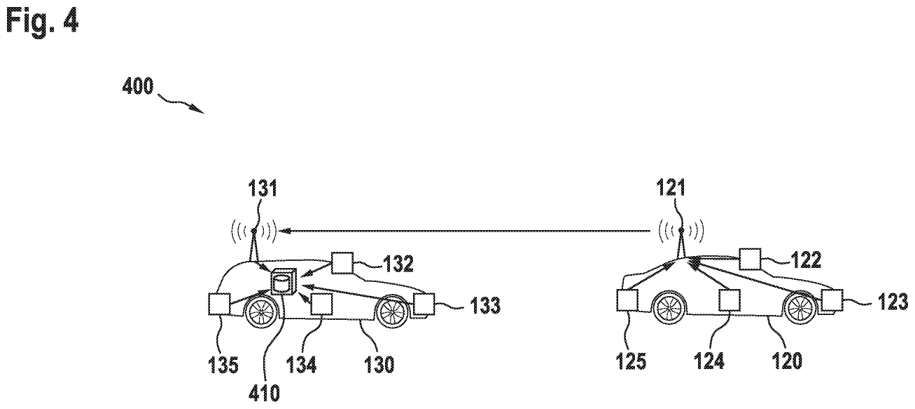

FIG. 4 shows a further drawing of the signal flows for the generation of a reference representation with a decentralized computation.

### DETAILED DESCRIPTION OF EXAMPLE EMBODIMENTS

Illustration 100 of FIG. 1 shows how, for the generation of a reference representation of the surroundings of an at least semi-automated mobile platform 130, at least one third-party platform 110 and a further third-party platform 120 are ascertained in a step S1 for receiving reference data for the reference representation of the surroundings of the mobile platform. In a further step S2, a communication channel of mobile platform 130 is established to the at least one third-party platform 110, 120.

In a further step S3, the reference data of at least one third-party platform 110, 120 are received for the reference representation of the surroundings of mobile platform 130. In a further step S4, the received reference data that are relevant to the generation of the reference representation are ascertained by mobile platform 130.

In a further step S5, the relevant reference data of the at least one third-party platform 110, 120 are stored for the generation of the reference representation of the surroundings. This storing may take place on a non-volatile memory 136 of mobile platform 130. In this exemplary embodiment, the reference data of the at least one platform 110 are made available to mobile platform 130 with the aid of sensors 112, 113, 114, 115 or of the further platform with the aid of sensors 122, 123, 124, 125 and transmitted via a wireless connection 111 through 131 and a further wireless connection 121 through 131 to mobile platform 130. In this case, at least semi-automated platform 130 generates a representation of the surroundings of mobile platform 130 with the aid of sensors 132, 133, 134, and 135.

The generation of the reference representation of the surroundings of at least semi-automated mobile platform 130 may take place with the aid of holistic algorithms, in that not only past and instantaneous data, but also future data, viewed starting from the contemplated event, are taken into account for the determination of an object attribute of the surroundings.

This example method may be applied, for example, in the case of field validation or verification of new algorithms or systems:
if a new object recognition was developed from surroundings sensors, for example, this method may be used to request the position of another vehicle, i.e., a third-party platform, in the surroundings of the mobile platform, which has the corresponding object recognition, and to then compare it to the data of this new object recognition.
if a new algorithm was developed for traffic light recognition, by way of a further example, the traffic light state ascertained by the algorithm may be used to compare the received state of a correspondingly equipped traffic light for validation purposes.
if a new system for vehicle localization was developed, by way of a further example, the ascertained ego position of the system may be compared to the position, in which another vehicle, i.e., a mobile third-party platform or an infrastructure camera, has detected the ego vehicle, i.e., the mobile platform, for validation purposes.
for validating a newly developed emergency braking function (AEB), the trigger decision of the AEB function may be compared with the representation of the surroundings of a vehicle that is proximately located and is equipped with better sensors.

Moreover, this method may be used to generate ground truth data from field data of a plurality of vehicles to test existing or new algorithms on cloud servers against these generated field data. In this case, the verification or validation does not take place in the vehicle itself, but the data are transmitted to a server, where they are available for offline processing.

Illustration 200 of FIG. 2 shows how in a further step, the reference data, which are received from third-party platforms 110, 120 and stored, are transmitted from mobile platform 130 to a server 210 or server cluster 210, which includes memories 220, 225 and on which the computation of the representation may take place with the aid of holistic algorithms. During the transmission, data that were generated by the mobile platform itself may also be transmitted.

Illustration 300 in FIG. 3 shows how according to another aspect of the method, the sensor data measured in the vehicle and the reference data received from at least one third-party platform 120 may be transmitted via a wireless connection, such as for example an Internet connection, during the driving operation to mobile platform 130 on a server computer 210 or on a sever cluster 210 outside of mobile platform 130. Here, server computer or server cluster 210 is configured to generate a reference representation of the surroundings of the at least one semi-automated mobile platform.

Illustration 400 of FIG. 4 shows how according to one aspect of the example method, the sensor data generated by the mobile platform itself with the aid of sensors 132, 133, 134, 135 and the reference data that were received from at least one third-party platform and generated with the aid of sensors 122, 123, 124, 125 are used by mobile platform 130 to generate a reference representation, in that algorithms are generated for the generation of a reference representation of the surroundings of the mobile platform on the hardware of the mobile platform. In this case, a further algorithm is used to make a selection from the overall present sensor data and the received reference data, so that a reference representation of the surroundings is generated automatically only for some of the measured data. Mobile platform 130 includes a corresponding processing unit 410 for the generation of the reference representation from these data.

What is claimed is:

1. A method for generating a reference representation of the surroundings of an at least semi-automated mobile platform, comprising the following steps:
ascertaining at least one third-party platform for receiving reference data for the reference representation of the surroundings of the mobile platform;
establishing a communication channel of the mobile platform to the at least one third-party platform;
receiving the reference data of the at least one third-party platform for the reference representation of the surroundings;
ascertaining the received reference data that are relevant to generation of the reference representation; and
storing the reference data of the at least one third-party platform for the generation of the reference representation of the surroundings.

2. The method as recited in claim 1, wherein the received reference data include sensor data having information for the representation of the surroundings of the mobile platform.

3. The method as recited in claim 1, wherein the received reference data include object attributes of the representation of the surroundings of the third-party platform of objects of the surroundings of the mobile platform.

4. The method as recited in claim 1, wherein the received reference data include information with regard to environmental conditions of the surroundings of the mobile platform.

5. The method as recited in claim 1, wherein the received reference data include information, requested by the mobile platform, with regard to the representation of the surroundings of the mobile platform.

6. The method as recited in claim 1, wherein at least some of the received reference data include a quality degree of the reference data.

7. The method as recited in claim 1, wherein the received reference data are relevant to the generation of the reference representations of the surroundings of the mobile platform, insofar as either a new reference representation of the surroundings may be generated using the received reference data or an instantaneous reference representation of the surroundings is improved using the received reference data.

8. The method as recited in claim 7, wherein the received reference data improve the generation of the instantaneous reference representations of the surroundings, insofar as that they make it possible to add further object attributes of objects for the instantaneous reference representation of the surroundings or check present object attributes or improve the quality of present object attributes.

9. The method as recited in claim 1, wherein the received reference data are only stored for the reference representation of the surroundings when a minimum of information about the surroundings together with the received reference data is present for the mobile platform.

10. The method as recited in claim 1, wherein the received reference data are stored using a memory of the mobile platform and transmitted to an external central processing unit after the driving operation or the received reference data are transmitted to an external central server during the driving operation, the external central processing unit being configured to generate the reference representation of the surroundings.

11. The method as recited in claim 1, wherein the mobile platform is configured to generate reference representations of the surroundings for at least some of the received reference data and to store the generated reference representations with using a memory of the mobile platform.

12. The method as recited in claim 1, wherein: (i) based on the received reference data, a control signal for activating an at least semi-automated vehicle is made available, and/or (ii) based on the received reference data, a warning signal for warning a vehicle occupant is made available.

13. A device configured to generate a reference representation of the surroundings of an at least semi-automated mobile platform, the device configured to:
ascertain at least one third-party platform for receiving reference data for the reference representation of the surroundings of the mobile platform;
establish a communication channel of the mobile platform to the at least one third-party platform;
receive the reference data of the at least one third-party platform for the reference representation of the surroundings;
ascertain the received reference data that are relevant to generation of the reference representation; and
store the reference data of the at least one third-party platform for the generation of the reference representation of the surroundings.

14. A non-transitory machine-readable memory medium on which is stored a computer program for generating a reference representation of the surroundings of an at least semi-automated mobile platform, computer program, when executed by a computer, causing the computer to perform the following steps:
ascertaining at least one third-party platform for receiving reference data for the reference representation of the surroundings of the mobile platform;
establishing a communication channel of the mobile platform to the at least one third-party platform;
receiving the reference data of the at least one third-party platform for the reference representation of the surroundings;
ascertaining the received reference data that are relevant to generation of the reference representation; and
storing the reference data of the at least one third-party platform for the generation of the reference representation of the surroundings.
